(19) United States
(12) Patent Application Publication
(10) Pub. No.: US 2014/0359557 A1
(43) Pub. Date: Dec. 4, 2014

(54) CREATING APPLICATIONS

(71) Applicant: MICROSOFT CORPORATION, Redmond, WA (US)

(72) Inventors: TASNEEM RANGWALA, SUNNYVALE, CA (US); RAYMOND K. PON, SAN JOSE, CA (US); JEAN-FRANCOIS COURTOIS, MOUNTAIN VIEW, CA (US); DEEPA RAMACHANDRAN, LOS ALTOS, CA (US); GOPINATH VAGEESAN, FREEMONT, CA (US); THOMAS M. BRANT, SAN JOSE, CA (US); SUDHA GOPAL, DUBLIN, CA (US)

(21) Appl. No.: 13/906,485

(22) Filed: May 31, 2013

(51) Int. Cl. G06F 9/44

(52) U.S. Cl. CPC G06F 8/35
USPC 717/105

(57) ABSTRACT

Methods, computer systems, and computer-storage media are provided for creating applications. Entities may request that applications be generated by an application creator but still shipped and branded as that of the entity. A single code may be used to create one or more predefined templates used to create applications for many entities. A plurality of branding elements may be included in the predefined templates such that the applications are customized and branded for the entity.

### BACKGROUND

Applications are becoming increasingly common among many different operating systems. Applications, as used herein, refer generally to a program that is associated with a specific entity. With constant updates to both applications and operating systems, media partners may be limited in their ability to stay current with application design. A media partner, as used herein, refers generally to an entity associated with an application. Several factors may contribute to this such as a lack of developmental resources, a lack of design resources after various upgrades, and the like. Media partners may be in a position to rely on third party creators to assist in application creation.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, creating applications. In particular, the present invention seeks to create applications using a single code bank including one or more templates for application creation. Media partners may submit various data to application creators. The data may be fed into an application template in a system that is configured to read various metadata files and associate appropriate data with a corresponding entry in the application template. The data may include branding data for the media partner such that the application is branded. Branding data may include, but is not limited to, colors associated with an entity, a logo associated with an entity, and the like.

Accordingly, in one embodiment, the present invention is directed to one or more computer-storage media having computer-executable instruction embodied thereon that, when executed by one or more computing devices, perform a method of creating applications. The method comprises, receiving a request to generate an application, identifying a requesting entity associated with the request, receiving information associated with the requesting entity, receiving content to be included in the application, and creating the application, including the content, using a predefined template.

In another embodiment, the present invention is directed to a computer system for creating applications. The system comprises one or more processors coupled to a computer storage medium, the computer storage medium having stored thereon a plurality of computer software components executable by the processor, the computer software components comprising a receiving component for receiving a request to create an application from a requesting entity, an identifying component for identifying information associated with the requesting entity and content to be included in the application, an associating component for associating the content and the information associated with the requesting entity with a corresponding entry of a predefined template, a generating component for creating the application, and a communicating component for communicating the application to the requesting entity.

In yet another embodiment, the presented invention is directed to one or more computer-storage media having computer-executable instruction embodied thereon that, when executed by one or more computing devices, perform a method of creating applications. The method comprises receiving a request to generate a first application, identifying a first requesting entity associated with the request, receiving information associated with the first requesting entity, receiving content to be included in the first application, associating the content and the information associated with the first requesting entity with a corresponding entry of a predefined template, creating the first application, including the content, using the predefined template, receiving a request to generate a second application from a second requesting entity, receiving information associated with the second requesting entity, receiving content to be included in the second application, associating the content and the information associated with the second requesting entity with corresponding entries of the same predefined template, and creating the second application using the same predefined template used to create the first application.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for creating applications suitable for use in implementing embodiments of the present invention;

FIG. 3 is a flow diagram of an exemplary method of creating applications in accordance with an embodiment of the present invention;

FIG. 4 is a flow diagram of an exemplary method of creating applications in accordance with an embodiment of the present invention; and

FIG. 5 depicts an illustrative screen display, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, creating applications. In particular, the present invention seeks to create applications using a single code bank including one or more templates for application creation. Media partners may submit various data to application creators. The data may be fed into an application template in a system that is configured to read various metadata files and associate appropriate data with a corresponding entry in the application template. The data may include branding data for the media partner such that the application is branded. Branding data may include, but is not limited to, colors associated with an entity, a logo associated with an entity, and the like.

Exemplary media partners may include news providers, sports providers, and the like. The media partners may desire to have applications in most application stores, including application stores associated with the most recent upgraded technology. For instance, touch-enabled operating systems (such as Windows® 8) offer various features that may not be available in non-touch systems. As a result, application creators may be asked to create a large number of applications for a plurality of media partners. The present invention enables the application creators to create numerous applications for one or more media partners using a single code base. Various templates may exist within the code base such that media partners may edit certain features, such as fonts, colors, backgrounds, etc., but a single code base is utilized. This enables the application creator to easily and quickly create many applications that are built by the application creator but shipped and branded as that of the partner.

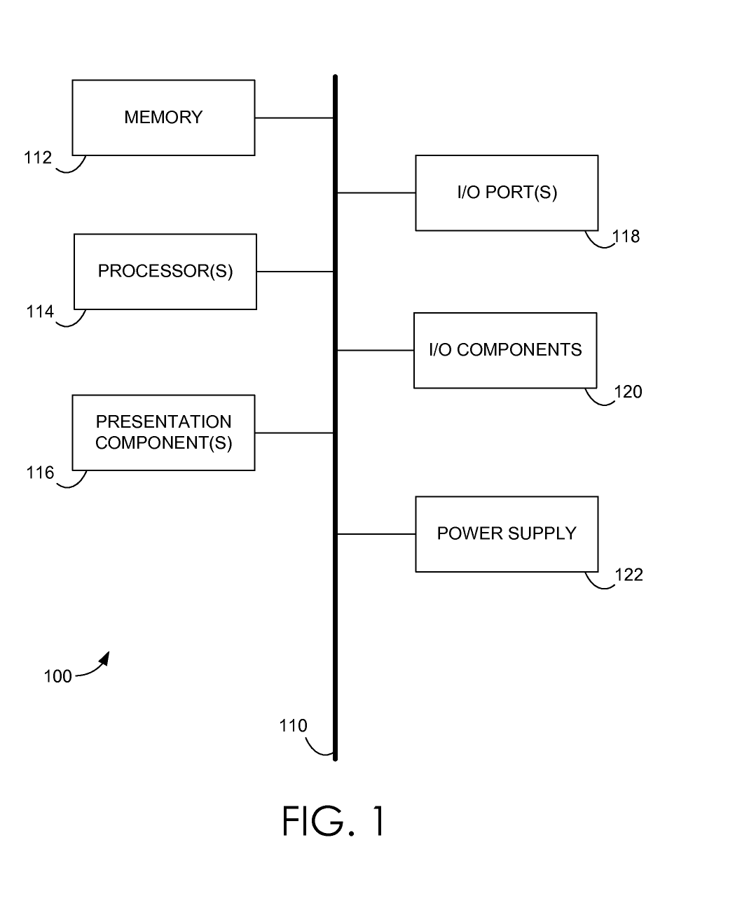

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, an application creation service, a content manager, a Web browser, a cloud server, a set of one or more processes distributed on one or more computers, one or more stand-alone storage devices, a set of one or more other computing or storage devices, a combination of one or more of the above, and the like.

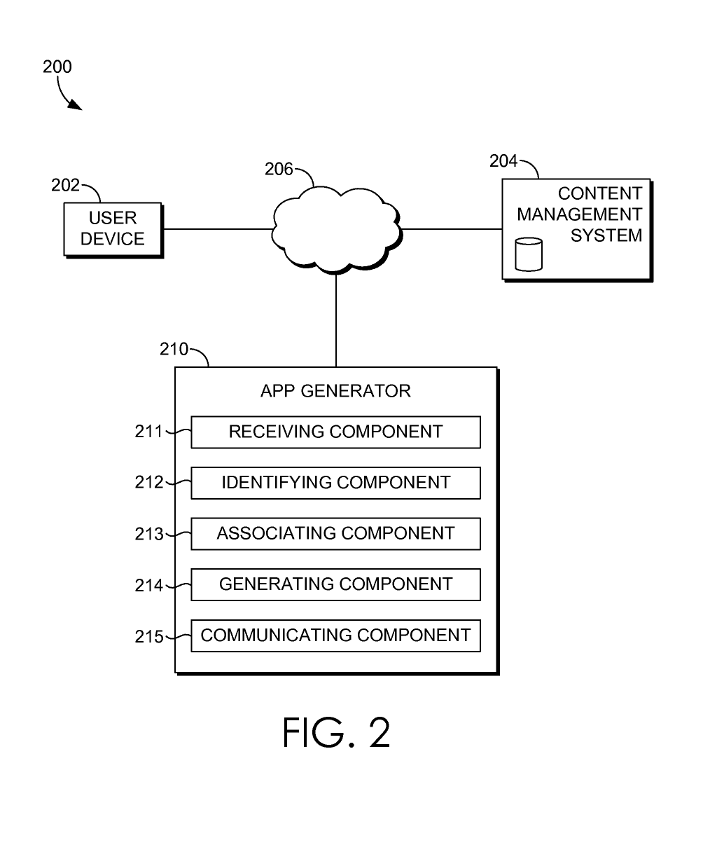

Referring now to FIG. 2, a block diagram is provided illustrating an exemplary computing system 200 in which embodiments of the present invention may be employed. Generally, the computing system 200 illustrates an environment where applications are created.

Among other components not shown, the computing system 200 generally includes a user device 202, a content management system 204, a network 206, and an application generator 210. The user device 202 may be any device capable of requesting, displaying, launching, etc., an application. Exemplary user devices include, but are not limited to, tablets, mobile phones, desktops, laptops, and the like.

The content management system 204 may include one or more databases to store various data. The content management system 204 may be any type of system capable of storing data. The content management system 204 may index data based on various criteria. Exemplary data stored in the content management system 204 may include, but is not limited to, data associated with various entities, such as media partners, content data to be included in applications, and the like.

The network 206 may include, without limitation, one or more local area networks (LANs) and/or wide area networks (WANs). Such networking environments are commonplace in offices, enterprise-wide computer networks, intranets and the Internet. Accordingly, the network 206 is not further described herein.

The application generator 210 may be any device capable of generating applications. The application generator 210 may include a receiving component 211, an identifying component 212, an associating component 213, a generating component 214, and a communicating component 215.

The receiving component 211 may be configured for, among other things, receiving information. The information may include, but is not limited to, a request to generate an application, metadata from an entity, metadata associated with an entity that has been stored in the content management system 204, content of an application (again, from an entity or a database), and the like. Requests to generate applications may be from an entity for one or more applications or from a plurality of entities for a plurality of applications.

Metadata associated with an entity may include, among other things, a name desired for the requested application, a name of the entity, a logo of the entity, contact information of the entity, links associated with an entity (such as a link to an entity's web page, etc.), colors desired in the application, additional design choices such as fonts, styles, backgrounds, etc., and various behavior aspects. Behavior aspects of an application indicate how the application may react to a received input. For example, Windows® 8 includes live tiles that may react in different ways upon identifying a user selection. An entity may identify how the live tile will react in the behavior aspect of the submitted metadata.

The identifying component 212 may be configured to, among other things, identify an entity associated with a request, metadata associated with an entity, and the like. For instance, when a request to generate an application is received, the identifying component 212 may be configured to identify that Entity A communicated the request. Thus, the identifying component 212 would then identify that metadata associated with Entity A is needed (either from Entity A or from the content management system 204).

The associating component 213 may be configured for, among other things, associating an entity with corresponding metadata, associating metadata with corresponding entries of a predefined template, and the like. The predefined template, as explained above, may include various entries for metadata including, but not limited to, a color scheme entry, a logo entry, a name of entity entry, and the like. The metadata corresponding to the appropriate entry is identified and associated with the appropriate entry in the predefined template. The predefined template may include predefined schema to brand the content within the application. For instance, the template may include accent bars that are placed in specific locations or that are specific colors associated with an entity. Background elements, including background colors, images, and the like, may also be available within the template in order to brand the application. An exemplary set of brand elements may include, but is not limited to, accent bars, logos, layouts, font colors, sizes, styles, etc., and the like.

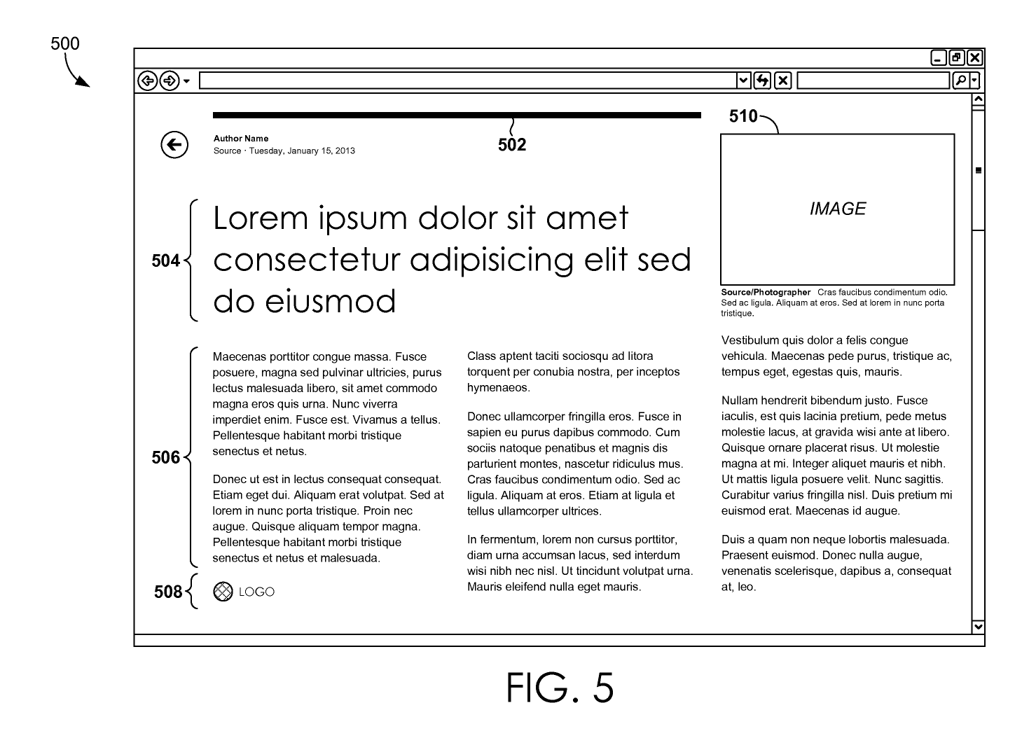

An exemplary application screen shot 500 is provided in FIG. 5. The screen shot illustrates an accent bar 502 that may be branded to be any color desired by an entity. Reference numeral 504 indicates a title of content 506 that was indicated in metadata communicated from an entity. The content 506 may be constantly updated as new information is received by the system 200. Logo 508 is an additional branded element that may be any symbol and color designated by the entity. Some restrictions may be present, such as size, but this is a branding element that is, for the most part, completely at the discretion of the entity. The screen shot 500 also indicates an image 510 that was read from metadata and can be in a variety of locations depending on a layout chosen by the entity (and indicated in the metadata). Not shown in FIG. 5 is a background element that may be customized by an entity.

The associating component 213 may associate data from any location with the predefined template. In embodiments, the data is included in the content management system 204 but it may be located anywhere that is accessible to an associating component.

The generating component 214 may be configured for, among other things, generating an application package. An application package, as used herein, refers generally to a package communicated to an entity that includes, among other things, an installable file of the created application that is ready to be installed into an app store. An app store, as used herein, refers generally to any location (including virtual locations) where one or more applications are available to users. An application package is not meant to be editable by the entity, but may be. While the application package is not intended to be editable by an entity, the application package may be edited at any time by the application creator. Since the metadata is present in the content management system 204, it can be tweaked at any time and a new package may be generated including the edits.

The generating component 214 may also be configured to generate an application package that includes one or more applications where the one or more applications are in different languages. For instances, the application package may include an English-US application that is in English and intended to be distributed in a US app store but may also include a FRFR (French-France) application that is in French and intended to be distributed in France.

The generating component 214 may dynamically render updated application packages based on new content received from, for example, the content management system 204. A news application, for instance, may be updated often to include updated news content. In this case, an entity may submit updated content (e.g., a news story) to the system and the generating component 214 may generate an updated application package such that the application will include the most up-to-date content.

The communicating component 215 may be configured for, among other things, communicating application packages to one or more entities. The communicating component 215 may communicate a plurality of application packages to an entity or may communicate application packages to multiple entities.

Not illustrated in FIG. 2 is a certification component that may be configured for, among other things, managing certification associated with applications. In embodiments, certification information includes a license key. Any other methods of certification may be utilized.

In an application, an entity (e.g., a media partner) may request that an application be generated and/or updated. The entity may either submit metadata to the system at the time of the request or the metadata may have been previously submitted to the system by the entity. Upon receiving the request, the system (e.g., the identifying component 212) may identify the entity associated with the request such that the appropriate metadata associated with the correct entity is accessed. The metadata is then read to identify relevant information to associate with corresponding entries in a predefined template used to create the application. For instance, the metadata may include the name of the application and the template will likely include an entry where the name of the application should be entered. The name of the application in the metadata may be associated with the corresponding entry in the predefined template.

Once the information is associated with the predefined template, the system (e.g., the generating component) may generate the application, including the branding elements identified in the metadata. Once generated, a preview may be available to the entity. The preview may include a preview of the metadata in the content management system as part of a web browser. Alternatively, the entity may preview the application upon receipt of an application package, including the application. If there are any changes the entity would like made, the application creator can easily modify the predefined template, generate an updated application, and communicate a new application package to the entity. Once an updated application package is received, or if there are no changes to be made to the original application package, an entity is then able to install the application directly into desired app stores. Thus, the application is created by the application creator (separate from the entity requesting the application) but is shipped and branded as that of the entity.

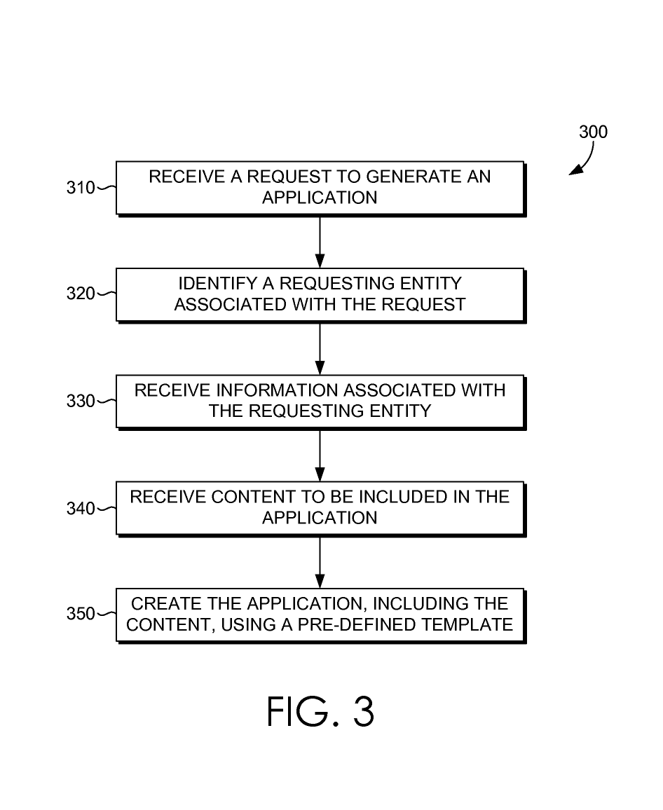

Turning now to FIG. 3, a process-flow diagram, referenced generally by the numeral 300, is depicted illustrating a method of creating an application. Initially, at block 310, a request to generate an application is received. This may be received directly from an entity to be associated with the application. At block 320 the requesting entity associated with the request is identified. At block 330, information (such as metadata) associated with the requesting entity is received. Content, in addition to the metadata, to be included in the application is received at block 340. The application, including the content, is created using a predefined template at block 350.

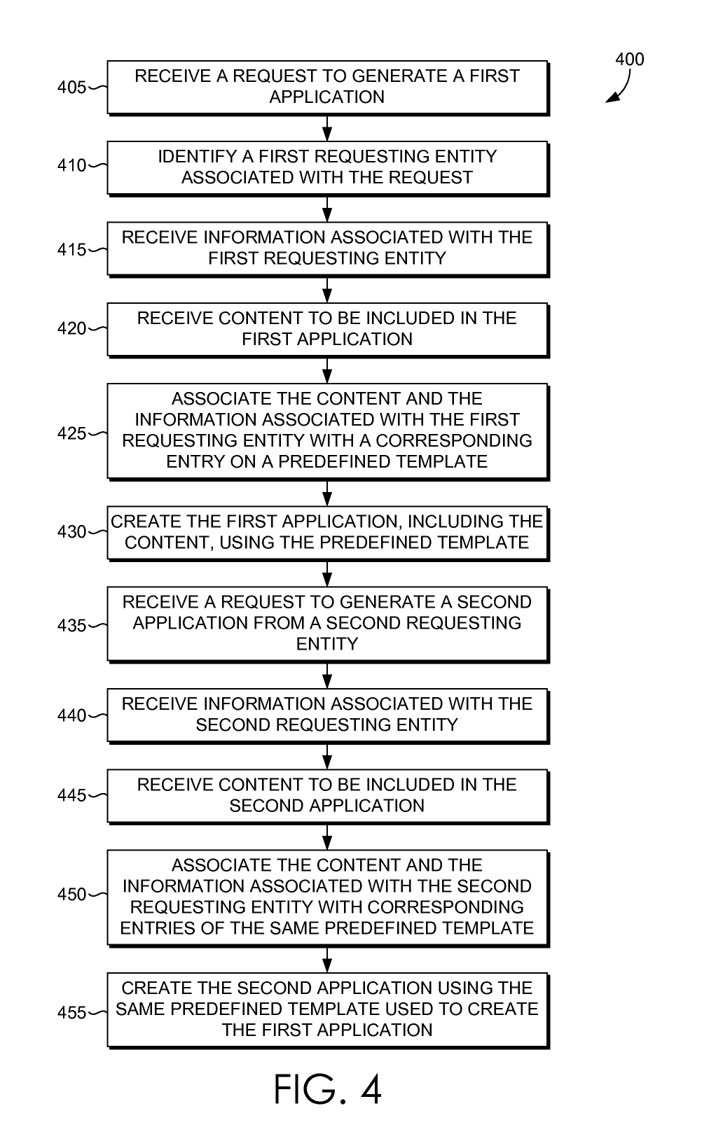

Turning now to FIG. 4, a flow diagram is depicted of an exemplary method 400 of creating applications. At block 405, a request to generate a first application is received. A first requesting entity associated with the request is identified at block 410. Information (such as metadata) associated with the first requesting entity is received at block 415 as well as receiving content to be included in the first application at block 420. The content and the information associated with the first requesting entity is associated with a corresponding entry of a predefined template at block 425 and the first application, including the content, is created using the predefined template at block 430. A request to generate a second application from a second requesting entity, different from the first requesting entity, is received at block 435. Information associated with the second requesting entity and content to be included in the second application are received at blocks 440 and 445, respectively. The content and the information associated with the second requesting entity are associated with corresponding entries of the same predefined template at block 450. The second application is created using the same predefined template used to create the first application at block 455.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by one or more computing devices, perform a method of creating applications, the method comprising:
receiving a request to generate an application, wherein an application is a program executed by the one or more computing devices;
identifying a requesting entity associated with the request;
receiving information associated with the requesting entity;
receiving content to be included in the application; and
creating the application, including the content, using a pre-defined template.

2. The media of claim 1, wherein the information associated with the requesting entity is metadata including a name of the requesting entity and contact information of the requesting entity.

3. The media of claim 1, wherein the information associated with the requesting entity is one or more selectable links.

4. The media of claim 1, wherein the information associated with the requesting entity is one or more design options of the application, wherein at least one design option includes a layout of the application.

5. The media of claim 1, wherein the information associated with the requesting entity is one or more behavior options of the application, wherein a behavior option is an indication of how the application reacts to a received input.

6. The media of claim 1, wherein the information associated with the requesting entity is certification information.

7. The media of claim 1, further comprising communicating the application to the requesting entity.

8. A system for creating applications, the system comprising:
one or more processors coupled to a computer storage medium, the computer storage medium having stored thereon a plurality of computer software components executable by the processor, the computer software components comprising:
a receiving component for receiving a request to create an application from a requesting entity;
an identifying component for identifying information associated with the requesting entity and content to be included in the application;
an associating component for associating the content and the information associated with the requesting entity with a corresponding entry of a predefined template;
a generating component for creating the application; and
a communicating component for communicating the application to the requesting entity.

9. The system of claim 8, further comprising a database comprising metadata associated with one or more requesting entities and the content to be included in applications.

10. The system of claim 8, wherein the information associated with the requesting entity is the metadata including a name of the requesting entity and contact information of the requesting entity.

11. The system of claim 8, wherein the information associated with the requesting entity is one or more design options of the application, wherein at least one design option includes a layout of the application.

12. The system of claim 8, wherein the information associated with the requesting entity is one or more behavior options of the application, wherein a behavior option is an indication of how the application reacts to a received input.

13. The system of claim 8, wherein the information associated with the requesting entity is certification information.

14. One or more computer-storage media having computer-executable instructions embodied thereon that, when executed by one or more computing devices, perform a method of creating applications, the method comprising:
receiving a request to generate a first application, wherein an application is a program executed by the one or more computing devices;
identifying a first requesting entity associated with the request;
receiving information associated with the first requesting entity;
receiving content to be included in the first application;
associating the content and the information associated with the first requesting entity with a corresponding entry of a predefined template;
creating the first application, including the content, using the predefined template;
receiving a request to generate a second application from a second requesting entity;
receiving information associated with the second requesting entity;
receiving content to be included in the second application;
associating the content and the information associated with the second requesting entity with corresponding entries of the same predefined template; and
creating the second application using the same predefined template used to create the first application.

15. The media of claim 14, wherein the information associated with the first and second requesting entity is metadata including a name of a requesting entity and contact information of a requesting entity.

16. The media of claim 14, wherein the information associated with the first and second requesting entity is one or more design options of an application, wherein at least one design option includes a layout of the application.

17. The media of claim 14, wherein the information associated with the first and second requesting entity is one or more behavior options of an application, wherein a behavior option is an indication of how the application reacts to a received input.

18. The media of claim 14, wherein the information associated with the first and second requesting entity is certification information.

19. The media of claim 14, further comprising communicating the first application to the first requesting entity.

20. The media of claim 14, further comprising communicating the second application to the second requesting entity.
